(19) United States
(12) Patent Application Publication
(10) Pub. No.: US 2021/0044558 A1
(43) Pub. Date: Feb. 11, 2021

(54) METHODS AND SYSTEMS FOR EMAIL VERIFICATION

(71) Applicant: Trusona, Inc., Scottsdale, AZ (US)

(72) Inventors: Ori Eisen, Scottsdale, AZ (US); Hugh Jerome Steed, Berkshire (GB); David Michael Kopack, Scottsdale, AZ (US)

(21) Appl. No.: 17/013,308

(22) Filed: Sep. 4, 2020

Related U.S. Application Data
(63) Continuation of application No. PCT/US2019/021378, filed on Mar. 8, 2019.
(60) Provisional application No. 62/641,083, filed on Mar. 9, 2018.

(51) Int. Cl. H04L 12/58; H04L 29/06; G06K 19/06

(52) U.S. Cl. CPC H04L 51/30; G06K 19/06009; H04L 63/0838; H04L 63/126

(57) ABSTRACT

Provided herein are systems and methods for verifying emails. Upon request by a sender in relation to a sender's email, a verification system can generate a visual graphical code corresponding to an email identity of the sender's email, acquire image data of the visual graphical code from a recipient device with aid of optical detection apparatus, and process the image data to extract the email identity of the sender's email so that the recipient can verify whether the sender in fact sent the email.

### CROSS-REFERENCE TO RELATED APPLICATIONS

This application is a Continuation application of International PCT Application No. PCT/US2019/021378, filed on Mar. 8, 2019, which claims the priority and benefit of U.S. Provisional Application No. 62/641,083 filed on Mar. 9, 2018, the entire content of which is incorporated herein by reference.

### BACKGROUND

Identity theft or identity fraud may refer to the use by one person of another person's personal information, without that other person's authorization, to deceive or defraud a third person. Many types of identity fraud may exist, and email fraud may be one of them. Forms of email fraud may include, but are not limited to, spoofing, prize scams, phishing, and/or business email compromise (BEC). Spoofing may include a situation where a fraudulent user poses as a sender that a recipient knows or trusts to send an electronic mail (or “email”) to the recipient. In such an email, the fraudulent user may request personal and sensitive information from the recipient.

Phishing may include a situation where a fraudulent sender uses emails that appear to come from a legitimate company or institution, such as a recipient's bank or university, to request personal and sensitive information from the recipient. A fraudulent sender may also use more sophisticated scamming schemes—Business Email Compromise (BEC)—to specifically target businesses that regularly perform financial transfer payments (e.g., wire transfers) into directing such payments to a fraudulent destination. Oftentimes, manually verifying a sender of an email can be cumbersome and time-consuming for users.

### SUMMARY

Recognized herein is the need for methods and systems for verifying emails from senders to recipients, thus preventing identity fraud. Although “email” is used herein to represent an example of online communications, any types of online communications can be verified by the methods and systems disclosed herein. The online communications may include, but not limited to, emails, short message services (SMS), chats, forums, and whiteboards.

A recipient of an online communication, such as an email, may wish to verify that the online communication was sent from a trusted, known, and/or otherwise verified sender. In some instances, a sender of an email can be a preregistered user of a verification system for facilitating verification of online communications. In some instances, a recipient of an email can be a preregistered user of the verification system. The verification system may generate a visual graphical code embedded in a body of each email sent by the sender. The image data of the visual graphical code may represent an email identity of the sender's email. The visual graphical code may then be sent to a recipient along with the sender's email. The verification system may process the image data of the visual graphical code captured by the recipient to extract the email identity of the sender's email. The verification system may thereafter access the email identity of the sender's email to (1) verify that the sender has sent the particular instance of the email, and (2) communicate the verification of the particular instance of online communication to the recipient.

Provided are systems and methods for verifying online communications. In an aspect, a verification session may comprise: (a) receiving, by a verification system, a request from a sender of the verification system, to create a visual graphical code corresponding to an email identity, wherein the email identity comprises information of an sender's email to a recipient; (b) generating the visual graphical code corresponding to the email identity, by the verification system, wherein the visual graphical code is configured to be displayed on a display screen; (c) acquiring image data of the visual graphical code from a recipient device with aid of optical detection apparatus, wherein the image data is acquired by capturing an image of the visual graphical code displayed on the display screen using an imaging device operably coupled to the recipient device and configured to optically detect the visual graphical code; (d) processing the image data to extract the email identity so that the recipient can verify whether the sender in fact sent the email. In some embodiments, the information of the sender's email may include an email address of the sender, an email address of the recipient, a content of the email, and a message hash related to the content of the email. In some embodiments, the display screen is external to the recipient device. In some embodiments, the visual graphical code is a one-time barcode that is uniquely associated with the email identity of the sender's email.

In another aspect, a system for verifying email communications may be provided. The system may comprise: i) a communication interface communicatively coupled to a network of devices, (ii) a user database, (iii) a memory for storing a set of software instructions and, and (iv) one or more processors configured to execute the set of software instructions to: (a) receive, via the communication interface, a request from a sender to create a visual graphical code corresponding to an email identity of an email; (b) generate the visual graphical code based on the email identity of the email; (c) embed the visual graphical code in a body of the email and send the email including the visual graphical code to a recipient; (d) receive, via the communication interface, a captured visual graphical code from a recipient device; and (e) compare an email identity decoded from the visual graphical code with the email identity of the email to authenticate the email.

In some embodiments, the request includes information about the email identity. In some embodiments, the email identity comprises an email address of a sender of the email, an email address of a recipient of the email and a checksum of the email. In some cases, the checksum of the email is uniquely associated with the email. In some cases, the checksum of the email is a hash on the content of the email. In some cases, the email identity further comprises a time stamp of the email, a name of the sender or a name of the recipient.

In some embodiments, the visual graphical code is a QR code. In some embodiments, the visual graphical code is displayed on a display of the recipient device. In some embodiments, the sender is a preregistered user of the system and one or more credentials of the sender is stored in the user database. In some embodiments, the one or more processors are configured to further send a verification result to the recipient via the communication interface.

In a related yet separate aspect, a method for verifying email communications is provided. The method comprises: (a) receiving a request from a sender to create a visual graphical code corresponding to an email identity of an email; (b) generating, with aid of one or more processors, the visual graphical code based on the email identity of the email; (c) embedding the visual graphical code in a body of the email and send the email including the visual graphical code to a recipient; (d) receiving a captured visual graphical code from a recipient device; and (e) comparing an email identity decoded from the visual graphical code with the email identity of the email to authenticate the email.

In some embodiments, the request includes information about the email identity. In some embodiments, the email identity comprises an email address of a sender of the email, an email address of a recipient of the email and a checksum of the email. In some cases, the checksum of the email is uniquely associated with the email. In some cases, the checksum of the email is a hash on the content of the email. In some cases, the email identity further comprises a time stamp of the email, a name of the sender or a name of the recipient. In some embodiments, the visual graphical code is a QR code. In some embodiments, the visual graphical code is displayed on a display of the recipient device. In some embodiments, the sender is a preregistered user. In some embodiments, the method further comprises sending a verification result to the recipient.

In an aspect, provided is a computer-implemented method for verifying an email from a sender to a recipient. The method may comprise: initiating a verification session, wherein the verification session is initiated by the recipient receiving the sender's email; verifying a visual graphical code of the sender's email with the verification server, wherein verifying the visual graphical code of the sender's email comprises determining that an email identity associated with the visual graphical code received by the recipient matches the email identity associated with the visual graphical code previously generated by the sender, wherein the email identity of the sender is stored in the verification server, upon verifying the email identity of the sender's email, sending a confirmation email to the recipient. In some embodiments, the method may further comprise receiving a confirmation of acceptance of the email from the recipient. In some embodiments, the recipient receiving the sender's email may reply to the email by sending another email to the sender.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an exemplary email to be sent to a recipient by a sender;

FIG. 2 shows an exemplary process flow diagram of a verification session;

FIG. 3 shows an exemplary schematic diagram of a user device capturing a graphical barcode during a verification session;

FIG. 4 shows an exemplary schematic diagram of how a verification system functions;

FIG. 5 shows an exemplary network layout comprising one or more verification systems; and

FIG. 6 shows an exemplary schematic illustration of a user device capturing a visual graphical code during a verification session.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

A user of a verification system may be used by an individual or entity that is capable of initiating (e.g., sending) or receiving an online communication. The online communication can be an email. The online communication can be any message sent from a first server to a second server via an online connection, such as a network. For example, the user can be a sender of an email. In another example, the user can be a recipient of an email. In some instances, the user can be a registered user of the verification system. A user can be registered to the system if the user has opened an online account with the system.

The online account may be dedicated to, and/or owned by, the user. User-specific information (e.g., name, email, organization, etc.) can be associated with a user's online account. Accordingly, the verification system can identify between registered users of the system by a user's online account. Access to an online account can be protected by associating user credentials, such as a username and accompanying password, of the user to the online account and requiring provision of the user credentials when a user requests access to the online account. Online accounts can be stored in a memory storage and/or a database of a server of the system.

An email identity may be dedicated to, and/or owned by, a sender. Sender-specific email information can be associated with the email identity. The sender-specific email information may be an email address of the sender, an email address of a recipient, and/or a content of the email. Access to the email identity can be protected by associating user credentials, such as a username and accompanying password, of the user to the online account and requiring provision of the user credentials when a user requests access to the email identity. The email identity can be stored in a memory storage and/or a database of a server of the system.

An online communication, such as an email, can involve a sender and at least one recipient. When a recipient receives an online communication from a sender, the recipient may typically be provided with information such as: a name (or display name) of the sender, an address (e.g., email address) of the sender which can also be a return path address, a name and/or address of other recipients (e.g., including recipients receiving a carbon copy (Cc)), a name (or display name) of the intended recipient, an address (e.g., email address) of the recipient, a receiving and/or sending time stamp of the online communication, a priority status (e.g., flags) of the online communication as indicated by the sender, a subject (or title) of the online communication, the content of the online communication (e.g., including a message and/or attachments), any other information relating to an identity of the sender or the recipient, and/or a combination of the above. A sender's address (e.g., email address) can be unique to the sender, and a recipient's address (e.g., email address) can be unique to the recipient. In certain instances, two or more senders or recipients may share the same address if credentials (e.g., password) are shared between them. A server may deliver an online communication to one or more servers.

In some instances, a recipient's online communication interface may be configured to enable the recipient to read the above information fields at a first glance before or after opening an email from an inbox. In other instances, the recipient's online communication interface (e.g., email interface) may be configured to enable the recipient to access or read one or more of the above information fields only by performing an additional action after having opened the email. The additional actions may include, but not limited to, clicking on a menu option, requesting such information from a mail server, and verifying the email is sent by the sender.

However, in some cases, neither the sending mail server nor the receiving mail server can be capable of verifying (or have means to verify) the authenticity of one or more of the above information fields. In such cases, a fraudulent sender may take advantage of the lack of verification by providing fraudulent information to be presented for one or more of the information fields to the recipient. For example, the fraudulent sender may freely select any name to display to the recipient (e.g., “FROM: John Smith” when the fraudulent sender's real name is “John Doe”). In another example, the fraudulent sender may freely select an email address of the fraudulent sender and/or a return path email address to display to the recipient (e.g., “FROM: John Smith <john.smith@domain.com>” when the fraudulent sender's real email address is “<john.doe@domain.com>”). That is, the fraudulent sender may mask his or her real identity with a genuine sender's identity by masking a name and/or an email address. Using such methods, the fraudulent sender may send an email on behalf of the genuine sender's email address without genuine sender's permission.

The sending mail server may perform no verification to ensure that the fraudulent sender is authorized to send on behalf of the genuine sender's email address. The receiving mail server may perform no verification to ensure that the email came from the fraudulent sender account having genuine sender's email address. A recipient may be especially susceptible to such fraudulent methods if the recipient is unaware that the fraudulent sender has the freedom to mask a display name or a return path email address with another, which is often the case. For example, recipients may be led to believe, such as by lack of sufficient warnings by one or more mail servers, that any information provided by the recipient's mail server and/or mail server interface, including the fraudulent sender's alleged display name and/or alleged return path email address, has been verified in some form by either the recipient's mail server or the sender's mail server.

Thus, a fraudulent sender can defraud a recipient by creating an impression to the recipient that a genuine sender has sent an email to the recipient. For example, the fraudulent sender can imitate or closely imitate a display name or email name of the genuine sender (e.g., the fraudulent sender sending an email with the name field “John Smith” and return email address field of “<john.smith@domain.co>,” intending for the recipient to confuse the email to have come from the genuine sender having the name “John Smith” and the email address “<john.smith@domain.com>”). In some cases, the fraudulent sender can imitate a communication style of the genuine sender, such as copying genuine sender's diction (e.g., opening statements, closing statements, disclaiming statements, shorthand habits, etc.) or writing format (e.g., how many spaces separate paragraphs, font, template, etc.).

In some cases, the fraudulent sender can mask a display name and/or email address with the display name and/or email address of the genuine sender, and send on behalf of the genuine sender's email address, as described above (e.g., the fraudulent sender sending with the return path email address of the genuine sender's email address of “<john.smith@domain.com>” when the fraudulent sender's real email address is “<john.doe@domain.com>”). In other cases, the fraudulent sender can attach one or more forged or authentic files (e.g., documents, letters, signatures, etc.) to make the recipient believe the email came from the genuine sender. In any of the above cases, or with other scamming methods, the recipient may find it difficult to recognize that it is not actually the genuine sender sending the email. In the process, the recipient may receive real and lasting damage from the communication by leaking personal and sensitive information or providing other assets of value to the fraudulent sender or at the fraudulent sender's instruction.

To prevent fraud, a recipient may resort to additional verification methods, including online (e.g., installing software or application modules configured to perform verification, providing a primary or secondary verification key (e.g., PIN code, passcode, one time password (OTP), etc.) unique to a recipient, providing a digital user identification certificate, etc.) and/or offline (e.g., manually verifying via a telephone call and verifying by voice, manually verifying in-person, etc.) methods. Oftentimes, manually verifying (e.g., via offline methods) an online communication can be cumbersome, counteractive, inefficient, and/or time-consuming for users. Similarly, other methods of verification can require a separate installation of bulk (or add-on) software or a separate obtaining of a verification key or other digital certificate which can be bulky, cumbersome, inefficient, and/or time consuming for users. Verification systems and methods provided herein may be used alternatively or in addition to these verification processes. The systems and methods provided herein can facilitate verification of online communication to prevent attempts of fraud such as fraud perpetuated via the methods described above, spoofing, scamming, phishing, and/or business email compromise (BEC).

When a sender sends an online communication, such as an email, to a recipient, the sender may wish to preemptively provide the recipient a verification of the sender's identity. For example, the sender may wish to provide the recipient a verification of his or her identity before the recipient makes such verification request. In some instances, the recipient of an online communication may wish to verify that the online communication was sent from a trusted, known, and/or otherwise verified sender. Provided are systems and methods for verifying online communications that may verify the identity of a sender's email of an online communication to a recipient.

A sender and/or a recipient may pre-register as a user with a verification system, such as by creating an online account with the verification system. The verification system may or may not verify an identity of a user during registration. In an example, the system may require in person authentication. In some cases, the system may require provision of one or more supporting documents (e.g., passport, driver's license, photo identification card, business organization licenses, etc.) either in person or via online transfer (e.g., as attachments in email, fax, etc.). In some cases, the system may use one or more other verification techniques as needed. The system may use a unique device identification (ID) or device identifier for a device owned by the user to verify the identity of the user. In some cases, the unique device ID can have been pre-associated with a verified user (e.g., by a device supplier, telecommunication provider, etc.). In some cases, an administrator of the system may deliver a device having a unique device ID (e.g., dongle, one-time password (OTP) generating device, etc.) to a user, such as via mail, and request the user to verify the user's identity with the delivered device.

For each registered user, the verification system may store one or more email addresses verified to be owned by the registered user, such as in a database. The verification system may only store an email address of a registered user if the registered user has verified the email address as the user's own to the verification system. For example, a user may verify an email address by successfully following instructions for verification in a confirmation email sent to that email address by the verification system (e.g., by a verification server of the verification system). Such instructions may include clicking on a unique confirmation link (e.g., URL) provided in the body of the email, re-entering a code or a password provided in the body of the email into another location (e.g., confirmation site), and/or any other instructions configured to uniquely verify a user. Alternatively or in addition, the verification system may further store other verified information of a user, such as a name, birth date, phone number, association to one or more organizations, position in one or more organizations, and/or other personal information. Such information can be verified accordingly by online or offline means (e.g., verifying copies of official documents, such as a passport, driver's license, business card, signed employment verification letter, text message to a provided phone number, etc.).

In some instances, the verification procedure can be more strict than the above (e.g., in person interview, etc.). For example, where an email address is associated with an organization (e.g., employees of an organization sharing a common organization domain of the email address), the verification system may require further proof of a user's association to the organization. For example, a user may be required to provide proof of employment, a copy of a business card, a copy of a membership card, a copy of a pay stub, a certified letter from a supervisor, or other proofs of association to an organization. In some instances, an organization subscribing to the services of the verification system may set its own verification procedure or standard with the verification system. In some instances, a registered user may store only one verified email address. In other instances, a registered user may store more than one verified email address if the registered user can sufficiently prove ownership of each email address. The verification system may thereafter access verified information of a registered user upon request by another registered user in relation to a particular instance of online communication.

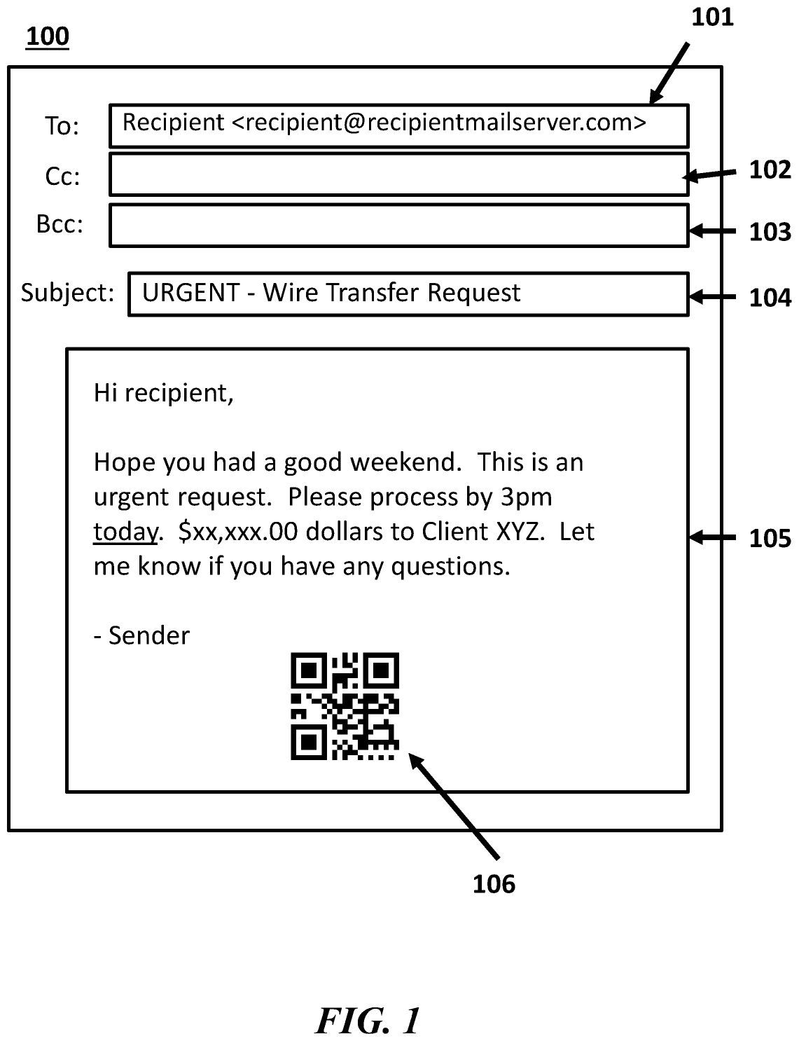

FIG. 1 shows an exemplary email 100 to be sent to a recipient by a sender. The sender may provide an email address (e.g., recipient@recipientmailserver.com) of an intended recipient in a “To” field 101 (as in FIG. 1). Alternatively or in addition, the sender can provide the email address of the intended recipient in a “Carbon copy” (Cc) field 102, and/or a “Blind carbon copy” (Bcc) field 103. The sender may provide a subject of the email 100 (e.g., “URGENT—Wire Transfer Request”) in a “Subject” field 104. The sender may provide a body of the email 100 (e.g., “Hi recipient, Hope you had a good weekend. This is an urgent request. Please process by 3 pm today. $xx, xxx.00 dollars to Client XYZ. Let me know if you have any questions. —Sender”) in a “Content” field 105. The email 100 may optionally contain a verification request. The sender may include a visual graphical code 106 in the email 100. The visual graphical code 106 may be included and displayed in the body of the email. For example, the visual graphical code may be placed at the bottom of the body of the email, at the top of the body of the email, or in the middle of the body of the email. The visual graphical code will be described in further detail below.

In some embodiments, the visual graphical code may be generated by a verification entity. The verification entity may be embodied as a server (e.g., verification server), a computing system, hardware, software, or a combination of hardware and software. For example, the visual graphical code may be generated using Application Programming Interface (API) or software development kit (SDK) provided by the verification server.

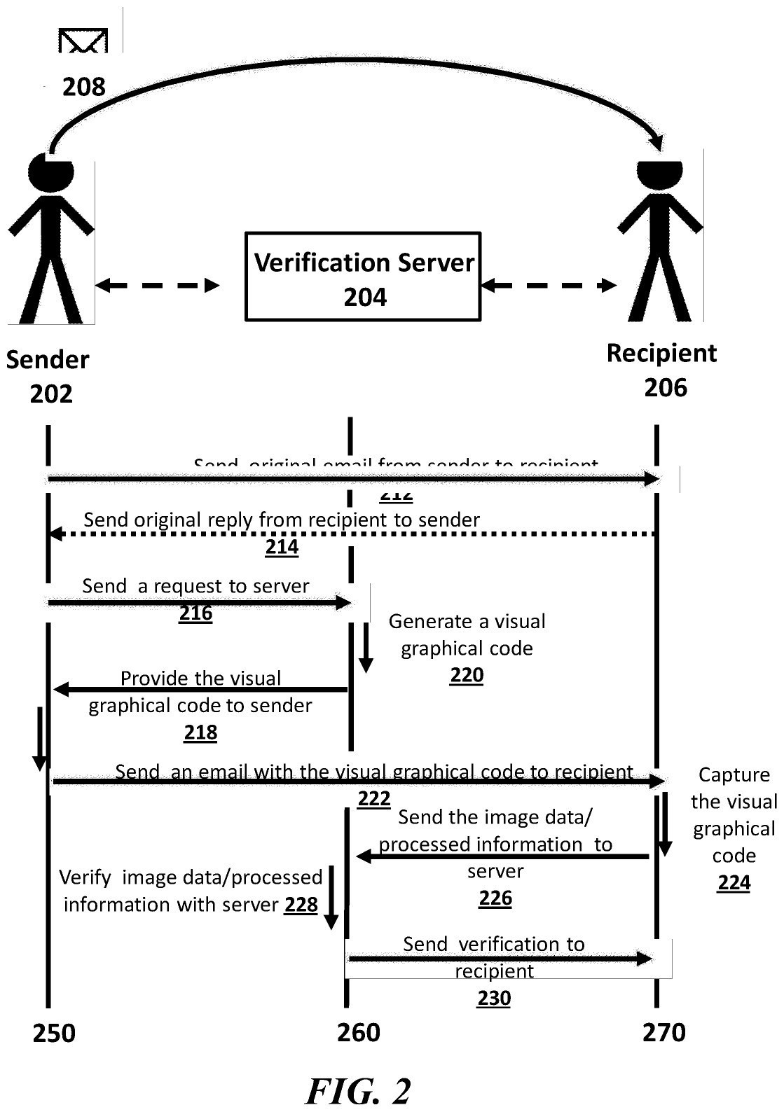

FIG. 2 shows an exemplary process flow diagram of a verification session. In FIG. 2, the process(es) carried out by or involving a sender 202 is represented by a contact with a vertical line 250, the process(es) carried out by or involving a verification server 204 is represented by a contact with a vertical line 260, and the process(es) carried out by or involving an intended recipient 206 is represented by a contact with a vertical line 270.

The sender 202 may send 212 an email 208 to the intended recipient 206 by including an email address of the intended recipient as a recipient of the email 208. The sender may send the email with aid of a first user device, and the intended recipient may receive the email with aid of a second user device. User devices will be described in further detail below. In an optional scenario, the original email may be received directly by the intended recipient without going through a verification session. In some instances, the recipient may reply 214 to the sender's original email without going through a verification session. In other instances, the recipient may send a request to the verification server 204 to require the sender to go through a verification session, otherwise the recipient may not read the sender's email. Upon receiving the request from the recipient, the verification server 204 may transmit the request to the sender. The sender may then either go through the verification session, as the recipient requests, or decline to go through the verification session. The sender may also initiate going through the verification session without the recipient's request. In preferred embodiment, the sender may go through a verification session regardless of request from the recipient. For example, an Application Programming Interface (API) or software development kit (SDK) provided by the verification server 204 may be installed on the sender's email server such that a visual graphical code may be automatically generated for each email.

To go through the verification session, the sender 202 may send 216 a request to the verification server 204 to create a visual graphical code corresponding to an email identity. The request may include the original email that the sender intended to send to the recipient. The original email may include information such as: a name (or display name) of the sender, an address (e.g., email address) of the sender which can also be a return path address, a name and/or address of other recipients (e.g., including recipients receiving a carbon copy (Cc)), a name (or display name) of the intended recipient, an address (e.g., email address) of the recipient, a receiving and/or sending time stamp of the online communication, a priority status (e.g., flags) of the online communication as indicated by the sender, a subject (or title) of the online communication, the content of the original email (e.g., including a message and/or attachments), any other information relating to an identity of the sender or the recipient, and/or a combination of the above. The request may further include data uniquely associated with content of the online communication. For instance, the data may comprise a message hash. The message hash may be generated as hash of the checksum of the email content. The data may comprise a hash value of the checksum of any portion of the email content or the entire email content. For example, the message hash may be generated through a checksum algorithm. The checksum algorithm may be a longitudinal parity check, Fletcher's checksum, Adler-32, or cyclic redundancy check.

The verification server 204 may generate 220 a visual graphical code corresponding to the email identity. The email identity may comprise information extracted from the aforementioned request. In an example, the email identity may comprise sender email address, recipient email address, and/or the message hash. The email identity may comprise various other data such as sender identity registered with the verification server. The email identity may be encrypted and encoded in the visual graphical code. The visual graphical code may be a one-time barcode that is uniquely associated with the email identity. The barcode may be a UPC barcode, EAN barcode, Code 39 barcode, Code 128 barcode, ITF barcode, CodaBar barcode, GS1 DataBar barcode, MSI Plessey barcode, QR barcode, Datamatrix code, PDF417 code, and Aztec barcodes. The visual graphical code may be configured to be displayed on a display screen.

Upon generating the visual graphical code, in some instances, the verification server 204 may send the visual graphical code back to the sender. The sender may then send 222 the original email with the visual graphical code to the recipient. In other instances, the verification server 204 may not send the visual graphical code back to the sender. The verification server 204 may incorporate the visual graphical code with the original email and then send the original email with the visual graphical code directly to the recipient.

Upon receiving the email with the visual graphical code, the recipient may capture 224 the visual graphical code displayed on a display screen of a recipient device. The recipient device may be a portable electronic device. The portable electronic device may be a mobile phone, tablet, smartwatch, digital camera, and personal navigation device. The recipient device may also be one or more computing devices configured to perform one or more operations consistent with the disclosed embodiments. For example, the recipient device may be the computing device that is capable of executing software or applications provided by the one or more verification servers. In some embodiments, the software and/or applications may enable the recipient to scan or acquire a visual graphical barcode displayed on another device, process the visual graphical barcode, and transmit verification notice to the recipient. The software and/or application may be registered with the verification server by the recipient. Optionally, the software and/or application may not be registered with the verification server, and the recipient device may be registered with the verification server.

The recipient device may comprise an imaging device. The imaging device may be an optical detection apparatus. The optical detection apparatus may optically read or scan a visual element. The imaging device may be a camera. The imaging device may be configured to be able to capture a visual graphical element, such as a bar code (e.g., one-dimensional, two-dimensional), text, a picture, a sequence thereof, or any other forms of graphical authentication indicia. The imaging device may include a hardware and/or software element. In some embodiments, the imaging device may be a hardware camera sensor operably coupled to the user device. For example, the camera sensor can be embedded in the recipient device. Alternatively, the imaging device may be located external to the user device, such as connected via cable or wirelessly, and image data of the graphical element may be transmitted to the user device via communication means as described elsewhere herein. The imaging device can be controlled by applications and/or software configured to scan a visual graphical code. For example, the camera may be configured to scan a visual graphical code. Optionally, the software and/or applications may be configured to activate the camera on the user device to scan the code. In some instances, the camera can be controlled by a processor natively embedded in the user device.

The recipient device may comprise a display device. The display device may be configured to display a visual graphical code (e.g. a QR code) to the recipient. In some embodiments, the visual graphical code may be displayed via an interface such as a webpage, application, program, or any appropriate software. The display device can be a monitor, a computer (e.g., laptop computer, desktop computer), a mobile device (e.g., smartphone, tablet, pager, personal digital assistant (PDA)), or a vending machine. In some cases, the recipient device may be a hand-held device. In some instances, the display device may comprise one or more processors natively embedded in the display device. The display device may optionally be portable. The display device may be handheld. The display screen of the display device may be a liquid crystal display (LCD), cathode ray tube (CRT), light emitting diode (LED) display, touchscreen, electronic paper (e-paper) display, or a display on a separate computing device.

An image data of the visual graphical code may be processed by the recipient device to reveal processed information. For example, the image of the visual graphical code may be decoded locally at the recipient device. The processed information may then be sent to the server 204 to be analyzed and verified. In some instance, to send the processed information, the recipient may exercise an action. The action may be clicking on a graphical object of a display screen of the display device. The graphical object can be an icon, a pop-up window, or a visual representation of any graphical shape. It should be noted that various characteristics of graphical elements can be used as the visual representation such as color, shape, and image contents. A recipient may be prompted to click or touch the graphical object to verify that the recipient wants to proceed with sending the processed information. For instance, a recipient may be provided a message (e.g., “Please click Accept to proceed.”) to verify whether the recipient intends to send the processed information by clicking or touching the graphical object (e.g., button shape graphical object).

The processed information may then be received and analyzed 228 by the verification server. The verification server 204 may be configured to receive any processed information decrypted by the recipient's device. Upon receiving the processed information, the system can extract an email identity associated with the processed information. The system may then verify 228 whether the email identity associated with the visual graphical code sent 226 by the recipient 206 matches the email identity associated with visual graphical code previously generated 220 by the sender 202. The verification server may search in the system and/or a database of the system for whether the email identity of the sender's email is stored in the verification server. In some instances, the verification server may store or retain processed information and/or an email identity of a sender's email only if the sender has registered with the verification server and has used the verification server to generate the visual graphical code. In other instances, the verification server may store or retain an email identity of a sender's email when the sender has used the verification server to generate the visual graphical code even if the sender has not registered with the verification server.

An image data of the visual graphical code may also be sent 226 to the verification server directly. In some instance, to send the image data of the visual graphical code, the recipient may exercise an action. The action may be clicking on a graphical object of a display screen of the display device. The graphical object can be an icon, a pop-up window, or a visual representation of any graphical shape. It should be noted that various characteristics of graphical elements can be used as the visual representation such as color, shape, and image contents. A recipient may be prompted to click or touch the graphical object to verify that the recipient wants to proceed with sending the image data. For instance, a recipient may be provided a message (e.g., “Please click Accept to proceed.”) to verify whether the recipient intends to send the image data by clicking or touching the graphical object (e.g., button shape graphical object). In other instances, to send the image data, the recipient may not exercise any action. The image data of the visual graphical code may be sent to the verification server automatically once the visual graphical code has been captured by the recipient.

The image data may then be processed and analyzed 228 by the verification server. Alternatively, the image data may be processed locally at the recipient device. The verification server 204 may be configured to receive any image data of the visual graphical code captured by the recipient device. A receipt of the image data can trigger a series of operations by the verification server. Upon receipt of the image data of the visual graphical code 226, the system can process the image data and extract an email identity. Upon extracting the email identity, the system can verify 228 whether the email identity associated with the visual graphical code sent 226 by the recipient 206 matches the email identity associated with visual graphical code previously generated 220 by the sender 202. The verification server may search in the system and/or a database of the system for whether the email identity is stored in the verification server. In some instances, the verification server may store or retain an email identity of a sender's email only if the sender has registered with the verification server and has used the verification server to generate the visual graphical code. In other instances, the verification server may store or retain an email identity of a sender's email when the sender has used the verification server to generate the visual graphical code even if the sender has not registered with the verification server.

If the system determines that the email identity associated with the visual graphical code sent 226 by the recipient 206 matches the email identity associated with visual graphical code previously generated 220 by the sender 202, the verification session may send 230 the recipient 206 a verification notice (e.g., verification email) from the verification server. The verification notice may be a verification email or a pop-up window displayed on the display screen. If the system determines that the email identity associated with the visual graphical code sent 226 by the recipient 206 does not match the email identity associated with visual graphical code previously generated 220 by the sender 202, the verification session can terminate at this point, and the recipient 206 may not receive a verification notice from the verification server. The lack of a verification notice can alert the recipient 206 that the sender 202 failed the verification session. Therefore, in some instances, the lack of a verification notice can be indicative that the email 208 was not sent by the genuine sender (e.g., a third user is attempting fraud by masking the third user's own email address with another user's email address).

If the system 204 determines that the email identity associated with the visual graphical code sent 226 by the recipient 206 matches the email identity associated with visual graphical code previously generated 220 by the sender 202, the system can send a confirmation email to the sender with the same email address as the email identity associated with. For example, this confirmation process can filter out a fraudulent sender masking their actual email address with the genuine sender's email address and thus fraudulently sending on behalf of the genuine sender without the genuine sender's knowledge or permission. The fraudulent user may not have access to the confirmation email because the fraudulent user does not have access (e.g., password, credentials, etc.) to the genuine sender's email address. The confirmation email sent to the genuine sender by the system can include a copy of the original email 208.

The genuine sender can verify based on this information (e.g., copy of original reply email, one or more information fields of the original reply email, etc.), if he/she in fact has sent the email 208. The confirmation email can comprise instructions for the genuine sender receiving the confirmation email to indicate confirmation or denial as to sending the email 208. The instructions can include clicking on a unique confirmation link (e.g., URL), button, or hyperlink provided in the body of the confirmation email, re-entering a code or a password provided in the body of the confirmation email into another location (e.g., confirmation site provided by the verification server), and/or any other instructions configured to allow for unique verification or denial. In some instances, the genuine sender can have a finite time restraint to follow through with either instruction, wherein at an expiration of the finite time restraint, the verification server may automatically receive a denial indication. Alternatively, the verified user can have an infinite amount of time to follow through with the verification instructions.

Upon receiving the denial instruction from the genuine sender, the verification server 104 may terminate the verification session. In some instances, upon receiving the denial instructions, the server may alert the recipient 206 of a possible fraud attempt such as via a denial notification email. In some instances, upon receiving the denial instruction via time expiration, the system may alert the recipient 206 that the verification session terminated due to expiration of time. If the sender verifies he/she sent the email 208, the verification server 204 can thus receive 222 confirmation from the sender 202. In some instances, the verification notification email can further include instructions for the recipient 202 to provide acceptance or denial of the email 208. The instructions for acceptance or denial can be the same or different instructions to verify or deny sending of the email 208 by the sender, such as described above. The recipient, having received verification notification, may accept the email 208 by following acceptance instructions. Alternatively, if a recipient who is not the intended recipient received the email 208 (e.g., because of clerical errors by the sender 202), the recipient can deny acceptance of the email 208 by following denial instructions.

In some instances, a recipient of the verification notification email can have a finite time restraint to follow through with either acceptance or denial instruction, wherein at an expiration of the finite time restraint, the verification server may automatically receive a denial indication. Alternatively, the recipient of the verification notification email can have an infinite amount of time to follow through with the acceptance or denial instructions.

Upon receiving the denial instruction from the recipient of the verification notification email, the verification server 204 may terminate the verification session. In some instances, upon receiving the denial instructions, the server may alert the sender 202 that the sender of the email 208 has denied acceptance. In some instances, upon receiving the denial instruction via time expiration, the system may alert the sender 202 and/or the recipient of the verification notification email that the verification session terminated due to expiration of time. Alternatively, the system may not send any notification to the sender 202 upon termination of the verification session (e.g., via expiration of time or affirmative denial).

If the recipient 206 accepts the email 208, the verification server 204 can thus receive confirmation that the recipient 206 received the email 208 from the sender 202. The verification server 204 can thereafter send the sender 202 an acceptance notification, such as via an acceptance notification email. Having received the acceptance notification, the sender 202 may be able to confirm that the recipient safely received the email 206. On the other hand, if the recipient 206 does not accept the email 208, the system 204 may not send the acceptance notification. For example, the recipient 206 may refuse to accept the email 208 if the sender does not recognize the email. The verification session can terminate upon the sender 202 receiving confirmation that the recipient 206 has accepted the email 208.

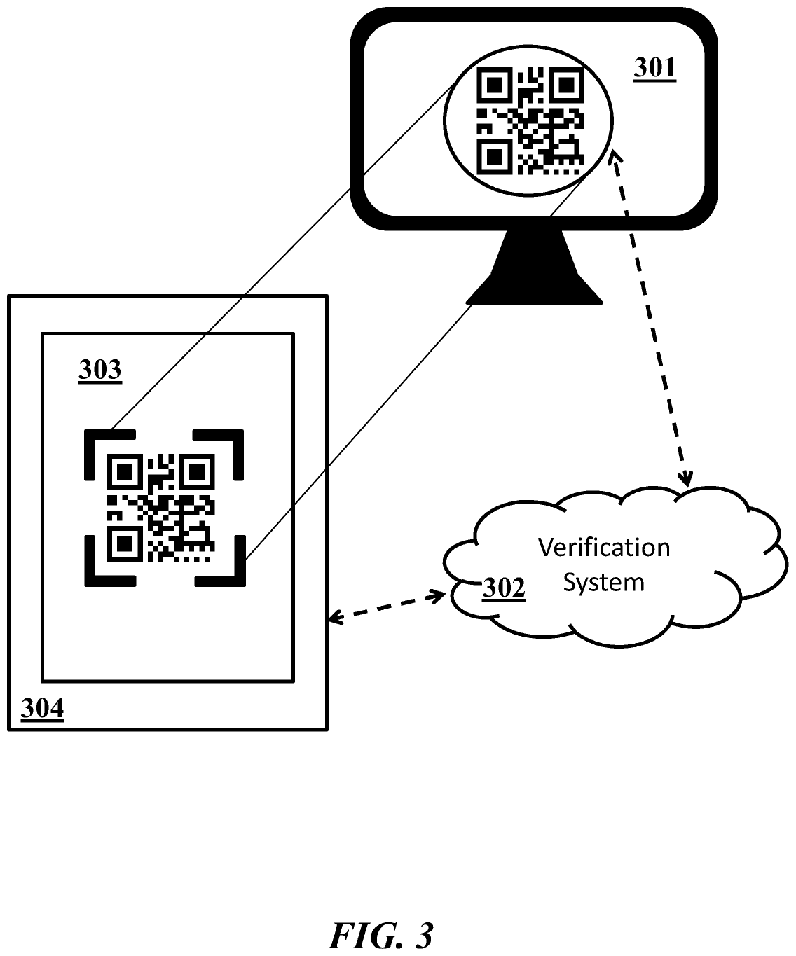

FIG. 3 shows an exemplary schematic illustration of a user device 304 capturing a graphical barcode in accordance with a verification session. The verification session may be hosted by a server on one or more interactive webpages, and accessed by one or more recipients. The user device 304 can be used to scan a visual graphical barcode such as a QR code displayed on a display device 301. The user device may be a device used by a recipient (or “recipient device”). The user device may also be a device used by a sender (or “sender device”). The QR code, or any other visual graphical barcodes, can be provided to the display device 301 by a verification system 302. The user device 304 and the display device 301 may be separate devices. Alternatively, the user device 304 and the display device 301 may be the same device. For example, a QR code can be displayed on the display screen of the user device 304. In such case, the imaging device may not be required to capture the QR code. For instance, the QR code displayed on user device 304 may be recognized upon receiving a user input (e.g., clicking on the QR code image to recognizing the QR code) via the same user device 304. The recognized QR code image may then be processed as normal. The user device 304 can be registered with the verification system 302.

The user device 304 may be a mobile device (e.g., smartphone, tablet, pager, personal digital assistant (PDA)), a computer (e.g., laptop computer, desktop computer, server), or a wearable device (e.g., smartwatches). A user device can also include any other media content player, for example, a set-top box, a television set, a video game system, or any electronic device capable of providing or rendering data. The user device may optionally be portable. The user device may be handheld. The user device may be a network device capable of connecting to a network, such as a local area network (LAN), wide area network (WAN) such as the Internet, a telecommunications network, a data network, or any other type of network.

The user device 304 may comprise memory storage units which may comprise non-transitory computer readable medium comprising code, logic, or instructions for performing one or more steps. The user device may comprise one or more processors capable of executing one or more steps, for instance in accordance with the non-transitory computer readable media. The user device may comprise a display showing a graphical user interface. The user device may be capable of accepting inputs via a recipient interactive device. Examples of such recipient interactive devices may include a keyboard, button, mouse, touchscreen, touchpad, joystick, trackball, camera, microphone, motion sensor, heat sensor, inertial sensor, or any other type of recipient interactive device. The user device may be capable of executing software or applications provided by one or more verification systems. One or more applications may or may not be related to reading codes such as graphical barcodes.

In some instances, the software and/or applications may allow the recipient to scan a graphical visual code such as a QR code displayed on another device or the same device, and transmit verification data between the user device 304 and the verification system 302 during a verification session. The software and/or application may have been registered with the verification system by the recipient. Optionally, the software and/or application need not be registered with the verification system, and only the user device may be registered with the verification system. Both the software and the user device can be registered with the verification system. Optionally, the software and/or application may be configured to collect verification data (e.g., image capture characteristics, time of capture, etc), and encrypt the data before sending them to the verification server (such as the server 201 in FIG. 2) during a verification session.

The user device 304 may be, for example, one or more computing devices configured to perform one or more operations consistent with the disclosed embodiments. The user device may be capable of optically detecting one or more visual element, such as a visual graphical code. The user device may utilize an optical detection apparatus. The optical detection apparatus may optically read or scan a visual element. In some embodiments, the user device may comprise an imaging device 303 which is configured to capture a visual graphical element, such as a bar code (e.g., one-dimensional, two-dimensional), text, a picture, a sequence thereof, or any other forms of graphical verification indicia that is being displayed on display device 301. The imaging device can include a hardware and/or software element. In some embodiments, the imaging device may be a hardware camera sensor operably coupled to the user device. For example, the camera sensor can be embedded in the user device. Alternatively, the imaging device may be located external to the user device, such as connected via cable or wirelessly, and image data of the graphical element may be transmitted to the user device via communication means as described elsewhere herein. The imaging device can be controlled by applications and/or software configured to scan a visual graphical code. For example, the camera may be configured to scan a QR code. Optionally, the software and/or applications may be configured to activate the camera on the user device to scan the code. In some instances, the camera can be controlled by a processor natively embedded in the user device. Optionally, if the display device 301 and the user device 304 are the same device, the imaging device can comprise a screen capturing software (e.g., screenshot) that can be configured to capture and/or scan a QR code on the screen of the user device 304.

The display device 301 may be configured to display a visual graphical code (e.g. a QR code) to the recipient. In some embodiments, the QR code may be displayed via an interface such as a webpage, application, program, or any appropriate software. The display device 301 can be a monitor, a computer (e.g., laptop computer, desktop computer), a mobile device (e.g., smartphone, tablet, pager, personal digital assistant (PDA)), a vending machine. In some instances, the display device may comprise one or more processors natively embedded in the display device. The display device may optionally be portable. The display device may be handheld.

In some instances, the visual graphical code displayed on the display device 101 and subsequently scanned by imaging device 303 may be a QR code. QR codes are two-dimensional barcodes that encode data by using dark and light modules arranged in a square-like or rectangular shape. QR codes can be optically captured and read by a machine. The barcode may define elements such as the version, format, position, alignment, and timing of the barcode to enable reading and decoding of the barcode. The remainder of the barcode can encode various types of information in any type of suitable format, such as binary or alphanumeric information. The QR code can have various symbol sizes as long as the QR code can be scanned from a reasonable distance by an imaging device. The QR code can be of any image file format (e.g. EPS or SVG vector graphs, PNG, TIF, GIF, or JPEG raster graphics format). The QR code can be based on any of a number of standards. In some instances, a QR code can conform to known standards that can be read by standard QR readers. The information encoded by a QR code may be made up of four standardized types (“modes”) of data (numeric, alphanumeric, byte/binary, kanji) or, through supported extensions, virtually any type of data. In some instances, the QR code may be proprietary such that it can be read only by an authenticated application, provided by the verification system, running on a user device. In some instances, only the verification system or the authenticated application can encrypt or decrypt the QR code.

The visual graphical code 301 may be uniquely associated with an email. In some embodiments, the visual graphical code may encode identity information of an email. In some embodiments, the identity information may include an email address of the intended recipient, the email address of a sender, and checksum of the email. The identify of an email can include other information such as a name (or display name) of the sender, a name and/or address of other recipients (e.g., including recipients receiving a carbon copy (Cc)), a name (or display name) of the intended recipient, a receiving and/or sending time stamp of the online communication, a priority status (e.g., flags) of the online communication as indicated by the sender, a subject (or title) of the online communication, the content of the original email (e.g., including a message and/or attachments), any other information relating to an identity of the sender or the recipient, and/or a combination of the above. The checksum of an email may comprise an email hash. The email hash may be generated as hash of the checksum of the email content. The data may comprise a hash value of the checksum of any portion of the email content or the entire email content. For example, the message hash may be generated through a checksum algorithm. The checksum algorithm may be a longitudinal parity check, Fletcher's checksum, MD5 checksum, SHA-1 (Secure Hash Algorithm 1), Adler-32, or cyclic redundancy check. Alternatively, the checksum may be generated using proprietary hash functions or algorithms. The checksum can be of any formats. For instance, checksum produced by a 28-bit (16-byte) MD5 hashes (also termed message digests) may be a sequence of 32 hexadecimal digits. In some cases, each email may have a unique checksum thus the visual graphical code may be uniquely associated with an email.

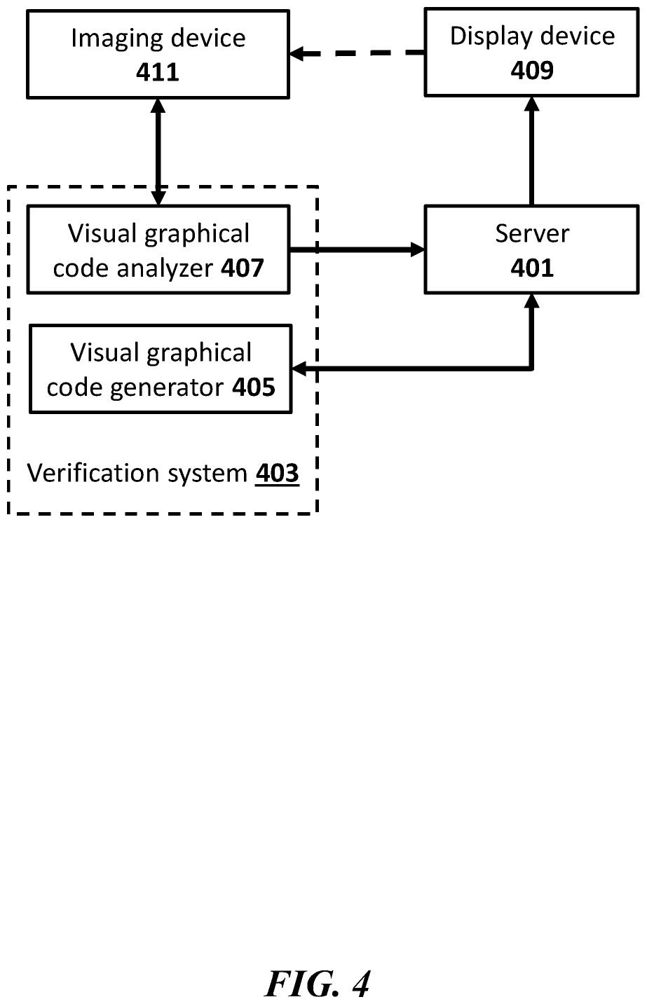

FIG. 4 shows an exemplary schematic diagram of how verification system functions. A server 401, at the command of a sender, may submit a visual graphical code request to a verification system 403. A server, as the term is used herein, may refer generally to a multi-user computer that provides a service (e.g. online transaction, database access, file transfer, remote access) or resources (e.g. file space) over a network connection. In some cases, the server 401 may be provided or administered by a third party entity in connection with a device provider. The one or more servers 401 may or may not be registered with the verification system 403. In some instances, the server may include a web server, an enterprise server, or any other type of computer server, and can be computer-programmed to accept requests (e.g., HTTP, or other protocols that can initiate data transmission) from a computing device (e.g., a user device, a public share device) and to serve the computing device with requested data. In addition, the server can be a broadcasting facility, such as free-to-air, cable, satellite, and other broadcasting facility, for distributing data. The server may also be a server in a data network (e.g., a cloud computing network).

The visual graphical code request may be initiated when a sender initiates a verification session. For example, the sender may directly request a visual graphical code from the verification system. The request may include the original email that the sender intended to send to a recipient. Upon receiving the request, the server 401 may first verify that the sender has been previously registered with the verification system and/or the sender is a trusted source or entity. A verified identity of the sender may be stored in a database accessible to the verification system. In some instances, the identity of the sender can be designated as a trusted source or entity by the verification system, such as via domain address, registration certificate, or other forms of evidence. Upon determining that the request came from a verified sender and/or the sender is a trusted source or entity, the verification system may respond to the request by sending a unique visual graphical code back to the requesting server. The server may then display the visual graphical code on the webpage portal so that the code can be displayed to the sender.

When the verification system 403 receives the request from the server 401, a visual graphical code generator 405 in the verification system may generate a unique visual graphical code corresponding to an email identity and a locator of the unique code. Generating a visual graphical code may comprise at least two steps: (1) generating a unique email identity, wherein the email identity comprises information of a sender's email, (2) encrypting the email identity into an image data, and (3) generating a one-time visual graphical code encoding the image data. The email identity may be unique to each online communication sent by the sender. The email identity or associated visual graphical code may expire after a certain period of time or once they have been validated.

The email identity may be encrypted by any suitable cryptographic techniques. The email identity can comprise any format and data type. For example, symmetric-key algorithms may be used for encryption and decryption. The keys can be composed from a sentence or a series of non-meaningful characters, and encryption can be done by performing a bitwise XOR operation on data chunks (e.g., original data, structure data and Reed-Solomon data) that compose the visual graphical code. The visual graphical code may be generated by choosing a number of random locations in data and changing the bytes in these locations randomly. The Reed-Solomon algorithm can correct wrongly decrypted code words and form the correct message. Any suitable visual graphical code may be used to represent the unique email identity, such as a one-dimensional or two-dimensional code, images, and so on.

The visual graphical code may be stored in a database accessible to the verification system 403. The verification system may retrieve the visual graphical code from the database via the unique email identity. Once the code is generated, a locator of the code may be provided to the server 401. In some instances, the locator can be a link or hyperlink associated with the code, such as a URL (uniform resource locator) to an IP (internet protocol) address or any other form of link that can enable a user using a browser to access the visual graphical code provided by a web server from the verification system. Alternatively, the visual graphical code may be sent directly to the server 401.

The server 401 may or may not store a copy of the code. In some instances, the server may only store the locator, whereas the visual graphical code can be stored in a database of the verification system 403. Allocating the storage of the visual graphical code to the database of the verification system may beneficially ease the burden of the server 401 in terms of memory space. In some instances, once the visual graphical code is received, the server may send the visual graphical code to the sender. The sender may then send the visual graphical code to the recipient along with the sender's email. In other instances, once the visual graphical code or locator is received, the server 401 may send the visual graphical code to a display device 409 configured to display the webpage portal of the recipient, along with the sender's email. In some instances, the display device 409 may correspond to the device 301 in FIG. 3. As previously mentioned, in some instances, the display device 409 may or may not be registered with the verification system 403. For example, the display device may be a publicly shared device. The display device 409 may be configured to be able to display an image such as a visual graphical code. Optionally, the display device may prompt the recipient to scan the visual graphical code via a message on the screen (e.g., “Please scan the Visual graphical code,” “Please take a picture of the visual graphical code,” etc.).

A recipient may use an imaging device 411 to scan the visual graphical code displayed on the display device 409. In some instances, the imaging device 411 in FIG. 4 may correspond to the imaging device 303 in FIG. 3. In some instances, the user device may comprise the imaging device. The imaging device may be configured to capture an image of the visual graphical code. Alternatively, the imaging device may be located on an external device such as an external camera sensor communicatively coupled (e.g., cables, wireless connection) to the user device. The captured visual graphical code may be transmitted to the user device via communication means such as cable or wireless connection. Optionally, the user device may comprise both the imaging device 411 and the display device 409, wherein the recipient may capture a visual graphical code displayed on the display screen of the user device using an imaging mechanism (e.g., screen capture). The imaging device can be controlled by an application/software to scan a visual graphical code.

The captured visual graphical code can be transmitted from the user device (e.g., recipient device 304 in FIG. 3) to a visual graphical code analyzer 407 in the verification system 403 for analysis. In some instances, the visual graphical code may be transmitted to the code analyzer via an application or software. The application or software may be provided by the verification system 403 and run on the user device. In some instances, the image data of the visual graphical code may be directly sent to the visual graphical code analyzer (e.g., in image format). Alternatively, the application or software may process the captured code (e.g. decode the code or decrypt the decoded data) and send the processed information to the visual graphical code analyzer for analysis.

The verification system 403 may analyze the visual graphical code for an email identity of the sender's email. The visual graphical code analyzer 407 may receive the code from the recipient device and decode the visual graphical code and/or decrypt the decoded data. In some instances, the visual graphical code analyzer may verify that the captured visual graphical code is associated the email identity generated by the sender. For example, if the email identity encrypted in a captured visual graphical code does not match any record of the email identity generated by the visual graphical code generator 405 of the verification system 403, then the lack of match can indicate a phishing attack. The verification system may notify the recipient that the visual graphical code is foreign to the verification system, alerting the recipient of the possibility that the sender which provided the particular visual graphical code to the recipient may be unverified sender.

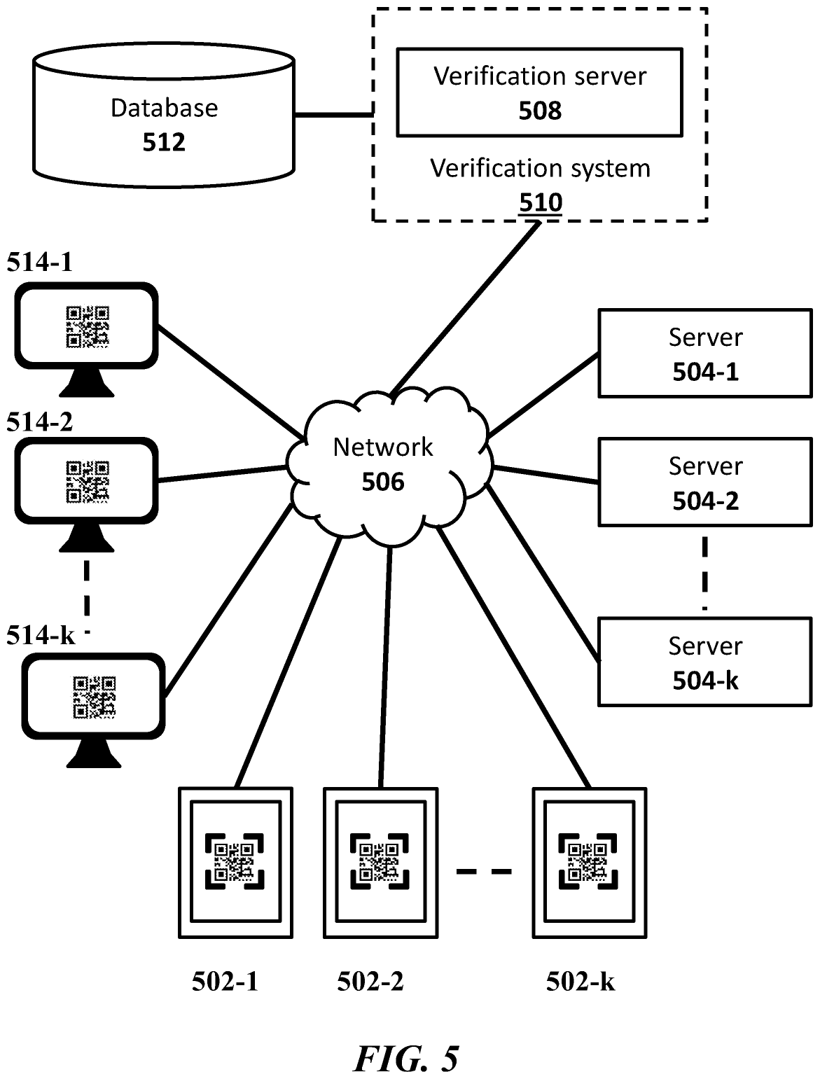

FIG. 5 illustrates an exemplary network layout comprising one or more verification systems, in accordance with some embodiments. In one aspect, the network layout may include a plurality of user devices 502, one or more servers 504, a network 506, one or more databases 512, a plurality of display devices 514, a plurality of verification servers 508, and one or more verification systems 510. Each of the components 502, 504, 508, 510 and 514 may be operatively connected to one another via a network 506 or any other type of communication link that allows the transmission of data from one component to another.

A user device 502, as described previously herein, can be, for example, one or more computing devices configured to perform one or more operations consistent with the disclosed embodiments. A user device may be a recipient device. Alternatively, a user device may be a sender device. A user device may be a computing device that is capable of executing software or applications provided by the one or more verification systems 510. In some embodiments, the software and/or applications may enable the user to scan a QR code or a visual graphical barcode displayed on another device, process the QR code or visual graphical barcode, and transmit verification data between the user device and the verification system during a verification session. The software and/or application may have been registered with the verification system by the user. Optionally, the software and/or application may not be registered with the verification system, and the user device can be registered with the verification system. As such, the user may or may not be required to login to the user's account with the verification system in order to proceed with the verification session.

In some embodiments, the application may be configured to collect authentication data to authenticate the recipient prior to scanning the QR code. In some cases, upon the authentication of the user identify, application may be accessed and the imaging device may be enabled to scan the QR code. The authentication data may comprise a credential such as something you know (e.g., PIN) and/or something you are (e.g. biometrics). For instance, a user may be asked to input a PIN, provide a fingerprint, facial scan, retinal scan or various other biometrics via a user device. In some cases, anti-replay features may be provided along with the credentials. In some cases, the collected authentication data may be encrypted then sent to the authentication server during an authentication session. The authentication server may be the same as the verification server 508. Alternatively, the authentication session may be hosted by the server 504 on one or more interactive webpages, and accessed by one or more users.

As described previously, the user device 502 may comprise an imaging device such as a camera and/or an imaging software. The camera and/or imaging software may be configured to be able to capture a QR code or a visual graphical barcode.

In some instances, the network 506 may comprise a plurality of user devices 502. Each user device may be associated with one or more users. The one or more users may be located geographically at a same location, for example users working in a same office or a same geographical location. In some instances, some or all of the users and user devices may be at remote geographical locations (e.g., different cities, countries, etc.), although this is not a limitation of the invention.

The network layout may comprise a plurality of nodes. A node may be part of a telecommunications network. A node may receive and/or relay information. A node may generate information that may be relayed. Each user device 502 in the network may correspond to a node. In FIG. 5, if a “user device 502” is followed by a number or a letter, it means that the “user device 502” may correspond to a node sharing the same number or letter and other components corresponding to the node. For example, as shown in FIG. 5, user device 502-1 may correspond to node 1 which is associated with user 1, display device 514-1, and server 504-1; user device 502-2 may correspond to node 2 which is associated with user 2, display device 514-2, and server 504-2; and user device 502-k may correspond to node k which is associated with user k, display device 514-k, and server 504-k, where k may be any positive integer.

A node may be a logically independent entity in the network layout. Therefore, the plurality of nodes in the network layout can represent different entities. For example, each node may be associated with a user, a group of users, or groups of users. For example, a node may correspond to an individual entity (e.g., an individual). In another example, a node may correspond to multiple entities (e.g., a group of individuals).

A user may be registered or associated with the verification system. One user may be associated with one or more user devices 502. The disclosed embodiments are not limited to any specific relationships or affiliations between the users and servers 504, databases 512, verification servers 508, and verification systems 510.

A user device 502 may be configured to receive input from one or more users. A user may provide an input to a user device using an input device such as, for example, a keyboard, a mouse, a touch-screen panel, voice recognition and/or dictation software or any combination of the above. Examples of other user interactive devices may include a button, touchpad, joystick, trackball, camera, microphone, motion sensor, heat sensor, inertial sensor, or any other type of user interactive device. The input may include a user performing various virtual actions during a verification session or before a verification session. The input may include, for example, a user login to an account of the application provided by the verification system or entering additional user information to complete an account opening session.

In the illustration of FIG. 5, two-way data transfer capability may be provided between any two components, including the verification server 508 and each user device 502, the server 504 and each user device 502, the verification server 508 and each server 504, the server 504 and each display device 514, etc.

A verification server 508 may comprise one or more server computers configured to perform one or more operations consistent with disclosed embodiments. In one aspect, a verification server may be implemented as a single computer through which a user device 502 is able to communicate with other components of the network 506. In some instances, a user device may communicate with the verification server through the network. In other instances, the verification server may communicate on behalf of a user device with the one or more verification systems 510 or the database 512 through the network. In one aspect, the verification server may embody the functionality of one or more verification systems. In another aspect, the one or more verification systems may be implemented inside and/or outside of the verification server. For example, the one or more verification systems may comprise software and/or hardware components included with the verification server or remote from the verification server. A verification server may also be a server in a data network (e.g., a cloud computing network).

In some instances, a user device 502 may be directly connected to the verification server 508 through a separate link (not shown in FIG. 5). In certain instances, the verification server may be configured to operate as a front-end device configured to provide access to one or more verification systems 510 consistent with certain disclosed embodiments. The verification server may, in some instances, utilize the one or more verification systems to process data provided by a user device (e.g., QR code image or image data) in order to compare and match the verification data (e.g., email identity, etc.) and user information requirement data for verification purposes and user information population purposes. The verification server may be configured to store the verification data and user information data for users in one or more databases 512. The verification server may also be configured to search, retrieve, and analyze (e.g., decrypt, decode, compare, etc.) verification data stored in the one or more databases.

In some instances, the server 504 may include a web server, an enterprise server, or any other type of computer server, and can be computer-programmed to accept requests (e.g., HTTP, or other protocols that can initiate data transmission) from a computing device (e.g., a user device, a public share device) and to provide the computing device with requested data. In addition, a server can be a broadcasting facility, such as free-to-air, cable, satellite, and other broadcasting facility, for distributing data. A server may also be a server in a data network (e.g., a cloud computing network).

A server 504 may comprise known computing components, such as one or more processors, one or more memory devices storing software instructions executed by the processor(s), and data. A server can have one or more processors and at least one memory for storing program instructions. The one or more processors can be a single or multiple microprocessors, field programmable gate arrays (FPGAs), or digital signal processors (DSPs) capable of executing particular sets of instructions. Computer-readable instructions can be stored on a tangible non-transitory computer-readable medium, such as a flexible disk, a hard disk, a CD-ROM (compact disk-read only memory), an MO (magneto-optical), a DVD-ROM (digital versatile disk-read only memory), a DVD RAM (digital versatile disk-random access memory), or a semiconductor memory. Alternatively, the methods disclosed herein can be implemented in hardware components or combinations of hardware and software such as, for example, ASICs (application specific integrated circuits), special purpose computers, or general purpose computers. While FIG. 5 illustrates the verification server 508 as a single server, in some embodiments, multiple devices may implement the functionality associated with the verification server.

The network 506 may be configured to provide communication between various components of the network layout depicted in FIG. 5. The network 506 may comprise one or more networks that connect devices and/or components in the network layout to allow communication between the devices and/or components. For example, the network may be implemented as the Internet, a wireless network, a wired network, a local area network (LAN), a Wide Area Network (WANs), Bluetooth, Near Field Communication (NFC), or any other type of network that provides communications between one or more components of the network layout. In some embodiments, the network may be implemented using cell and/or pager networks, satellite, licensed radio, or a combination of licensed and unlicensed radio. The network may be wireless, wired (e.g., Ethernet), or a combination thereof.

The one or more verification systems 510 may be implemented as one or more computers storing instructions that, when executed by one or more processors, can generate a plurality of visual graphical codes (e.g. QR codes) upon request from a server 504, and provide the codes or locators of the codes to the server 504. Users may scan the codes through user devices 502 and transmit the scan data back to the one or more verification systems. The one or more verification systems may either, based on the codes and/or the scan data, provide verification of an online communication. In some instances, the server may comprise the computer in which the one or more verification systems are implemented. Alternatively, the verification server 508 may comprise the computer in which the one or more verification systems are implemented. Alternatively, the one or more verification system may be implemented on separate computers.

The server may access and execute the one or more verification systems to perform one or more processes consistent with the disclosed embodiments. In certain configurations, the one or more verification systems may be a software stored in memory accessible by the server (e.g., in a memory local to the server or remote memory accessible over a communication link, such as the network). Thus, in certain aspects, the one or more verification systems may be implemented as one or more computers, as software stored on a memory device accessible by the server, or a combination thereof. For example, one verification system may be a computer hardware executing one or more verification techniques, and another verification system may be software that, when executed by the server, performs one or more verification techniques.

The disclosed embodiments may be configured to implement the one or more verification systems such that a variety of algorithms may be performed to execute one or more verification techniques and verification sequences, including provision of required user information after a verification is complete. Although a plurality of verification systems have been described for performing the above algorithms, it should be noted that some or all of the algorithms may be performed using a single verification system, consistent with disclosed embodiments.

The user devices 502, verification server 508, service provider server 504, and the one or more verification systems 510 may be connected or interconnected to one or more databases 512. The one or more databases may be one or more memory devices configured to store data (e.g., QR code, etc.). Additionally, the one or more databases may also, in some embodiments, be implemented as a computer system with a storage device. In one aspect, the one or more databases may be used by components of the network layout to perform one or more operations consistent with the disclosed embodiments. In certain embodiments, the one or more the databases may be co-located with the server, or co-located with the verification server, and/or co-located with one another on the network. One of ordinary skill will recognize that the disclosed embodiments are not limited to the configuration and/or arrangement of the one or more databases.

A display device 512 may be a device in that the identity of the device is not, and need not necessarily be, registered with the verification system. The display device may be a publicly shared device whose identity is not known to the verification system. As described previously, the display device may be configured to display a visual graphical code (e.g. QR code) and/or user interfaces (e.g., web portal, website) to the user. The visual graphical codes or locators of the codes may be transmitted to the display device from the server. In some embodiments, when a locator (e.g., URL) is provided, the QR code may be displayed via an interface such as a webpage or any software. The interface can be linked to the server via the locator (e.g., URL) to establish a communication between the user and the server. In other embodiments, the code may be directly transmitted to the display device and displayed to a user with or without an interface (e.g., webpage, web portal, software, etc.). The display device can be a computer (e.g., laptop computer, desktop computer), a mobile device (e.g., smartphone, tablet, pager, personal digital assistant (PDA)), a vending machine or the like requiring verification or verification of the user to open an online account on the server. The display device may optionally be portable. The display device may be handheld. The user device and the display device for any one node can be the same device. For example, user device 502-1 may be the same device as the display device 514-1, and the user device 502-2 may be the same devices as the display device 514-2.

Any of the user devices 502, the display devices 514, the servers 504, the one or more databases 512, and/or the one or more verification systems 510 may, in some embodiments, be implemented as a computer system. Additionally, while the network is shown in FIG. 5 as a “central” point for communications between components of the network layout, the disclosed embodiments are not limited thereto. For example, one or more components of the network layout may be interconnected in a variety of ways, and may in some embodiments be directly connected to, co-located with, or remote from one another, as one of ordinary skill will appreciate. Additionally, while some disclosed embodiments may be implemented on the server, the disclosed embodiments are not so limited. For instance, in some embodiments, other devices (such as one or more user devices) may be configured to perform one or more of the processes and functionalities consistent with the disclosed embodiments, including embodiments described with respect to the server and the verification system.

Although particular computing devices are illustrated and networks described, it is to be appreciated and understood that other computing devices and networks can be utilized without departing from the spirit and scope of the embodiments described herein. In addition, one or more components of the network layout may be interconnected in a variety of ways, and may in some embodiments be directly connected to, co-located with, or remote from one another, as one of ordinary skill will appreciate.

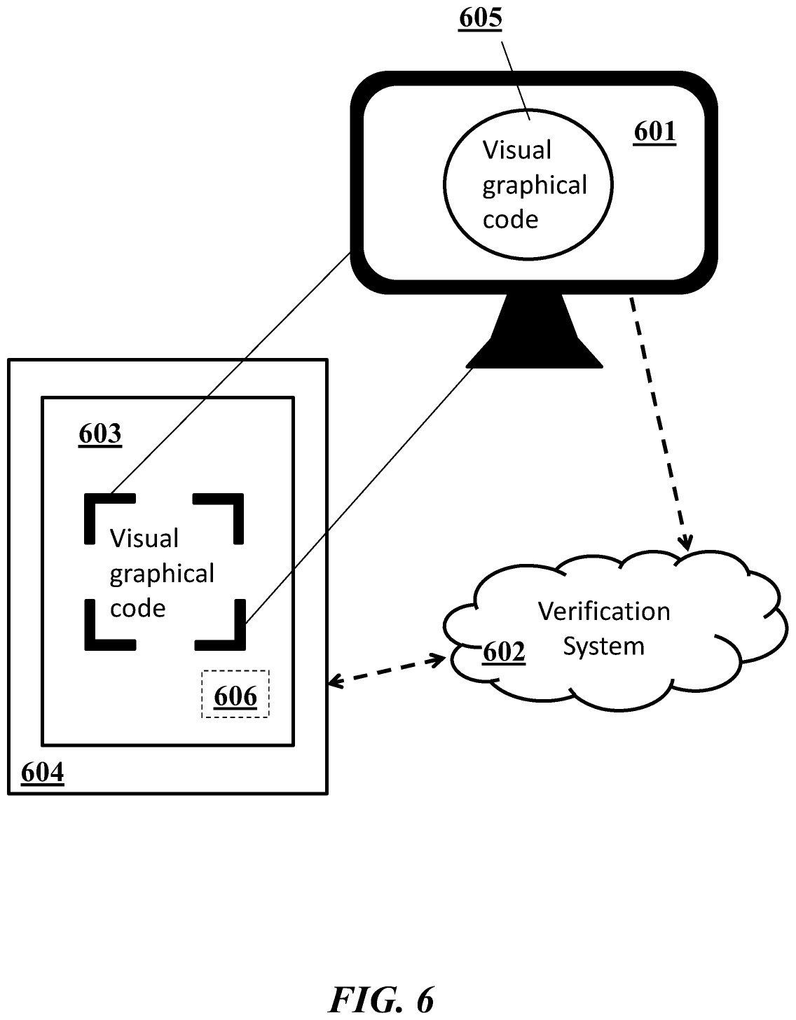

FIG. 6 shows an exemplary schematic illustration of a user device 604 capturing a visual graphical code in accordance with a verification session. The verification session may be hosted by a server (such as the server 201 of FIG. 2) on one or more interactive webpages, and accessed by one or more users. In some instances, the components, and functions and/or behaviors of the components, in FIG. 6 may correspond to the components, and the functions and/or behaviors of the components, in FIG. 3. In some instances, a component of FIG. 6 can be the same component of FIG. 3. For example, the user device 304 in FIG. 3 may correspond to the user device 604 in FIG. 6. For example, the imaging device 303 in FIG. 3 may correspond to the imaging device 603 in FIG. 6. For example, the display device 301 in FIG. 3 may correspond to the display device 601 in FIG. 6. For example, the verification system 302 in FIG. 3 may correspond to the verification system 602 in FIG. 6. All functions, capabilities, and connectivity of the components in FIG. 3 may apply to the components in FIG. 6.

The user device 604 can be used to scan a visual graphical code or graphical authentication indicia 605. The visual graphical code or graphical authentication indicia may be displayed on a display device 601. The user device 604 and the display device 601 may be separate devices or the same device. In some instances, the graphical authentication indicia may be provided on a physical object or be provided in the form of a physical object.

In some instances, a photo of the visual graphical code 605 may be acquired and stored on a memory unit of the user device 604 for further image processing and decoding. Alternatively, the imaging device 603 may scan the visual graphical code in real time without capturing a photo of the barcode. In some instances, the imaging device 603 may constantly acquire images of the visual graphical code and store them in memory. Each of these images can be subsequently processed by the user device until the visual graphical code is correctly decoded. Once the visual graphical code 605 has been decoded, the imaging device 603 may stop acquiring images of the visual graphical code.

In some instances, the user device 604 may comprise one or more sensors. The one or more sensors may be configured to collect data indicative of a state of the user device, a state of the imaging device and/or nonce data generated during a process. The one or more sensors may include, but are not limited to, location sensors (e.g., global positioning system (GPS) sensors, mobile device transmitters enabling location triangulation), vision sensors (e.g., imaging devices capable of detecting visible, infrared, or ultraviolet light, such as cameras), proximity sensors (e.g., ultrasonic sensors, lidar, time-of-flight cameras), inertial sensors (e.g., accelerometers, gyroscopes, inertial measurement units (IMUs)), altitude sensors, pressure sensors (e.g., barometers), audio sensors (e.g., microphones), time sensors (e.g., clocks), temperature sensors, sensors capable of detecting memory usage and/or processor usage, or field sensors (e.g., magnetometers, electromagnetic sensors). Any suitable number and combination of sensors can be used, such as one, two, three, four, five, or more sensors. Optionally, the data can be received from sensors of different types (e.g., two, three, four, five, or more types). Sensors of different types may measure different types of signals or information (e.g., position, orientation, velocity, acceleration, proximity, pressure, etc.) and/or utilize different types of measurement techniques to obtain data. For instance, the sensors may include any suitable combination of active sensors (e.g., sensors that generate and measure energy from their own source) and passive sensors (e.g., sensors that detect available energy).

Any number of sensors may be provided on-board the user device 604. The sensors may include different types of sensors, or the same types of sensors. The sensors and/or any other components described herein may be enclosed within a housing of the device, embedded in the housing of the device, or on an external portion of the housing of the device. The housing may or may not form a fluid-tight (e.g., water-tight or airtight) seal separating the interior of the housing and/or the exterior of the housing. Alternatively or in addition, the sensors may be external to the housing of the device and communicatively coupled, by cable or wirelessly, to the user device.

In some instances, the user device 604 may comprise a touch-sensitive touch screen 606. The touch-sensitive touch screen may provide an input interface and an output interface between the user device and a user. The touch screen may display visual output to the user. The visual output may include graphics, text, icons, video, and any combination thereof (collectively termed “graphics”). In some instances, some or all of the visual output may correspond to user-interface objects that instruct a user to, for example, confirm an online account opening process by touching a graphical button on the touch-sensitive touch screen. In some cases, a location of the touching may be recorded.

In some instances, the visual graphical code 605 displayed on the display device 601 can be any type of graphical code as described previously herein. The visual graphical code may be referred to as a visual graphical barcode or graphical authentication indicia. In some instances, the visual graphical code may be a one-time visual graphical code. The visual graphical code may expire or time out after a certain period of time or once it has been validated. The visual graphical code may encode data related to email identity as described elsewhere herein.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A system for verifying email communications comprising:
(i) a communication interface communicatively coupled to a network of devices, (ii) a user database, (iii) a memory for storing a set of software instructions and, and (iv) one or more processors configured to execute the set of software instructions to:
(a) receive, via the communication interface, a request from a sender to create a visual graphical code corresponding to an email identity of an email;
(b) generate the visual graphical code based on the email identity of the email;
(c) embed the visual graphical code in a body of the email and send the email including the visual graphical code to a recipient;
(d) receive, via the communication interface, a captured visual graphical code from a recipient device; and
(e) compare an email identity decoded from the visual graphical code with the email identity of the email to authenticate the email.

2. The system of claim 1, wherein the request includes information about the email identity.

3. The system of claim 1, wherein the email identity comprises an email address of a sender of the email, an email address of a recipient of the email and a checksum of the email.

4. The system of claim 3, wherein the checksum of the email is uniquely associated with the email.

5. The system of claim 3, wherein the checksum of the email is a hash on the content of the email.

6. The system of claim 3, wherein the email identity further comprises a time stamp of the email, a name of the sender or a name of the recipient.

7. The system of claim 1, wherein the visual graphical code is a QR code.

8. The system of claim 1, wherein the visual graphical code is displayed on a display of the recipient device.

9. The system of claim 1, wherein the sender is a preregistered user of the system and one or more credentials of the sender is stored in the user database.

10. The system of claim 1, wherein the one or more processors are configured to further send a verification result to the recipient via the communication interface.

11. A method for verifying email communications comprising:
(a) receiving a request from a sender to create a visual graphical code corresponding to an email identity of an email;
(b) generating, with aid of one or more processors, the visual graphical code based on the email identity of the email;
(c) embedding the visual graphical code in a body of the email and send the email including the visual graphical code to a recipient;
(d) receiving a captured visual graphical code from a recipient device; and
(e) comparing an email identity decoded from the visual graphical code with the email identity of the email to authenticate the email.

12. The method of claim 11, wherein the request includes information about the email identify.

13. The method of claim 11, wherein the email identity comprises an email address of a sender of the email, an email address of a recipient of the email and a checksum of the email.

14. The method of claim 13, wherein the checksum of the email is uniquely associated with the email.

15. The method of claim 13, wherein the checksum of the email is a hash on the content of the email.

16. The method of claim 13, wherein the email identity of the email further comprises a time stamp of the email, a name of the sender or a name of the recipient.

17. The method of claim 11, wherein the visual graphical code is a QR code.

18. The method of claim 11, wherein the visual graphical code is displayed on a display of the recipient device.

19. The method of claim 11, wherein the sender is a preregistered user.

20. The method of claim 11, further comprising sending a verification result to the recipient.
